(19) United States
(12) Patent Application Publication
(10) Pub. No.: US 2021/0194942 A1
(43) Pub. Date: Jun. 24, 2021

(54) SYSTEM, PLATFORM, DEVICE, AND METHOD FOR SPATIAL AUDIO PRODUCTION AND VIRTUAL REALITY ENVIRONMENT

(71) Applicant: Volta Audio LTD, London (GB)

(72) Inventor: Alexander KANE, London (GB)

(73) Assignee: Volta Audio LTD, London (GB)

(21) Appl. No.: 17/101,325

(22) Filed: Nov. 23, 2020

Related U.S. Application Data
(60) Provisional application No. 62/950,417, filed on Dec. 19, 2019.

(51) Int. Cl. H04L 29/06; G06T 19/00; G06F 16/435; G06F 3/01

(52) U.S. Cl. CPC H04L 65/4092; H04L 65/605; G06F 3/011; G06T 19/006; G06F 16/435; H04L 65/608

(57) ABSTRACT

A system, platform, device, and method for generating an immersive VR experience and producing spatialized audio in a virtual environment may be provided. For example, an embodiment may allow for creation of spatialized audio with a variety of parameters and qualities into a single virtual object. An exemplary embodiment may also allow for direct manipulation of a spatialized audio object in a virtual environment. Multiple digital audio workstations may be implemented simultaneously. Multiple users may interact with the objects in a networked environment. The virtual environment may be manipulated or viewed in virtual reality or augmented reality. For example, multiple users may virtually attend a virtual concert. The users may each have a unique perspective of the virtual concert. Each user may be viewing the concert in virtual reality. In another exemplary embodiment, the virtual environment may be edited or viewed in a desktop or smartphone application.

### BACKGROUND

Attending a concert in person is a fully immersive, social experience, triggering a rich array of emotional responses. Virtual, Augmented, and Mixed Reality (XR) mediums have the capability to create unforgettable experiences, and even go further into realms of artistic expression not possible in the physical world. However, creating these experiences is currently a highly specialized, technical process, involving proficiency with advanced programming languages such as C++ or C#, or familiarity with complex game engines such as Unity or Unreal Engine, and as such, is far beyond the skill set of most artists.

Furthermore, as an alternative to live performances, a platform that enables artists to create immersive audiovisual performances, perform to a global audience, and generate new revenue streams for the performing arts may therefore be desired.

Spatial audio is the next frontier of the music industry. The potential for spatial audio vastly exceeds conventional stereo because it allows the user to identify where the exact source of a sound is in a 3D orientation. Due to this capability, multiple formats and output technology have developed to support the use of spatial audio, including binaural and ambisonic audio.

Binaural audio uses two fixed points for audio recording and two channels for playback. In virtual reality settings, binaural audio limits the listener to a fixed location and cannot adjust the playback based on where the user moves within the virtual environment.

Ambisonics has existed since the 1970's, but remained largely unused at first, until the growth of surround sound home theatre systems and another surge coinciding with recent improvements to computer processing capabilities for real time adjustments.¹ Unfortunately, ambisonics optimally requires a ‘sweet spot’ for the listener and is not well suited for large scale concerts. Ambisonics requires the use of a B-format method which sends audio signal in a mix through four separate channels for processing before recombining them into a single signal. These four separate channels process the original signal as defined below, where S is the source signal, θ is the horizontal angle and Φ is the elevation angle: ¹ Brown, Harley “A Visual History of Spatial Sound”, Sep. 19, 2018. Red Bull Music Academy (available at daily.redbullmusicacademy.com/2018/09/a-visual-history-of-spatial-sound).
W=S/√2 | Sound pressure
X=S* cos θ cos Φ | front-minus-back sound pressure gradient
Y=S* sin θ cos Φ | left-minus-right sound pressure gradient
Z=S* sin Φ | up-minus-down sound pressure gradient² ² Arteaga, Daniel “Introduction to Ambisonics”, June 2015. Dolby Laboratories (available at www.researchgate.net/publication/280010078_Introduction_to_Ambisonics).

Wavefield Field Synthesis tackles the large space and crowd issue that ambisonics cannot adequately support. It achieves this by using multiple speakers in a square formation, all pointing inward, to create the perception of sound originating from a specific location within the enclosed area and removing the ‘sweet spot’ element.

As processing capabilities progressed to allow for real-time rendering, more industries have taken advantage of the capability to incorporate the versatile new tool. Movies, games, and virtual reality have all taken advantage of full sphere surround sound. Through ambisonics, spatial audio allows for viewers, players, and users to immerse themselves into the experience and to relate the visual surroundings with the sounds they hear (bullets whizzing past their heads, cars racing up from behind, and the rustling of other users).

Unfortunately, this has yet to be fully employed by the music industry because the means to create such audio remains unintuitive and disjointed from the creative composition and production process. Existing spatial audio tools are unintuitive and inadequate. Complex gaming engines and tools may be required to build a desirable interface or an intuitive audio production tool. Creating audio in this form may require knowledge of programming languages such as C++ or C#, or game engines such as Unity and Unreal Engine.

Digital Audio Workstations (“DAWs”) are the most common tools for composers and amateur producers. Currently, there are no DAWs that can support intuitive interaction and the expressive ways to compose and produce using embodied physical interaction.

Existing tools fail to provide the means for immersive editing and composition using direct human to audio object, object to object, and object to world interactions. Additionally, existing tools are incapable of interacting with a multitude of DAWs, limiting usefulness in the industry and the ability to enable a majority of artists.

Existing platforms further fail to provide the user with the interactive capabilities necessary for the intuitive design process because they rely on the same control means and representations that exist outside the virtual environment (knobs, sliders, etc.).

DAW interface mechanisms allow for external input devices to control the mechanizations within the DAW itself. The most common input devices include keyboards, but can take other forms, including virtual reality interface devices.

### SUMMARY

An exemplary system, platform, device, and method for spatial audio production may be described. The system, platform, device, and method may allow for creation of spatialized audio with a variety of parameters and qualities into a single virtual object. The system, platform, device, and method may also allow for direct manipulation of a spatialized audio object in a virtual environment. Further, an embodiment may also support multiple digital audio workstations simultaneously. An exemplary embodiment may allow for multiple users to interact with the objects in a networked environment.

An exemplary system for providing an audio-visual event may be provided. The system may include audio production software which may provide audio and audio metadata to a server. Audio metadata may include one or more adjustable parameters related to the audio. An exemplary system may also include a source video, a desktop application which combines the audio, audio metadata, and source video, and a server configured to store and stream the combined audio, audio metadata, and source video. The source video, audio, and audio metadata may be provided by an artist. An exemplary virtual reality app may also receive a set of audience data relating to one or more audience members. The audience members may simultaneously access the virtual reality app to simultaneously view the audio-visual event.

An exemplary method for producing an audio-visual event may be provided. The method may include capturing a source video from a performer and capturing audio from the performer or from audio production software. The audio may be mapped to a virtual environment. Values for various audio parameters may be mapped to environmental visual outputs. Audio parameter values may be adjusted by interacting with the environmental visual outputs, and the audio may be updated based on the adjusted audio parameter values. Finally, the method may include combining the audio and video in the virtual environment, which may be hosted on a server.

An exemplary embodiment may include a non-transitory computer-readable medium containing program code for producing an audio-visual event that, when executed, causes a processor to perform steps of: capturing a source video from a performer, capturing audio from a user or audio production software, mapping the audio to a virtual environment, mapping audio parameter values to environmental visual outputs, adjusting the audio parameter values based on interactions with the environmental visual outputs, updating the audio based on the adjusted audio parameter values, and combining the audio and source video in a virtual environment hosted on a server.

In an exemplary embodiment, audio may be spatialized to provide for the creation of an experience. An exemplary embodiment may provide a platform for an artist to edit an audio and/or video element in a virtual environment. The parameters and qualities of an audio element may be displayed as virtual objects which may be manipulated in the virtual environment, such as by increasing and decreasing their virtual size in order to increase or decrease the magnitude of that parameter. The virtual environment may be manipulated or viewed in virtual reality or augmented reality. For example, multiple users may virtually attend a virtual concert. The users may each have a unique perspective of the virtual concert. Each user may be viewing the concert live in virtual reality, while a performer performs in real time. The performer (as well as other users) may view real time feedback from audience members during performances, including statistics (such as viewership numbers). In another exemplary embodiment, the virtual environment may be edited or viewed in a desktop or smartphone application.

Users may create experiences in virtual and/or augmented reality easily, regardless of their technical knowledge or ability. The environment may be manipulated using a simple drag-and-drop style customization method. An exemplary embodiment may be integrated directly with existing DAWs, so that artist can easily integrate existing performance workflows into mixed reality platforms. A dashboard may be provided to facilitate in the scheduling and monetization of a user's live streams. Thus, an exemplary embodiment may allow a performer or user to easily create, perform, and generate revenue from their performances.

### BRIEF DESCRIPTION OF THE FIGURES

Advantages of embodiments of the present invention will be apparent from the following detailed description of the exemplary embodiments thereof, which description should be considered in conjunction with the accompanying drawings in which like numerals indicate like elements, in which:

FIG. 1 is an exemplary embodiment of a System for Spatial Audio Production and Virtual Reality Environment.

FIG. 2 is an exemplary embodiment of a Method for Spatial Audio Production and Virtual Reality Environment.

FIG. 3 is an exemplary embodiment of A Virtual Environment for A Platform for Spatial Audio Production.

FIG. 4 is an exemplary embodiment of A Virtual Environment for A Platform for Spatial Audio Production.

FIG. 5 is an exemplary embodiment of A Virtual Environment for A Platform for Spatial Audio Production.

FIG. 6 is an exemplary embodiment of A Virtual Environment for A Platform for Spatial Audio Production.

FIG. 7 is an exemplary embodiment of A Virtual Environment for A Platform for Spatial Audio Production.

FIG. 8 is an exemplary embodiment of A Performance Using a Platform for Spatial Audio Production and Virtual Reality Environment.

FIG. 9 is an exemplary embodiment of a System for Spatial Audio Production and Virtual Reality Environment.

FIG. 10 is an exemplary embodiment of a System for Spatial Audio Production and Virtual Reality Environment.

FIG. 11 is an exemplary embodiment of a System for Spatial Audio Production and Virtual Reality Environment.

FIG. 12 is an exemplary embodiment of a System for Spatial Audio Production and Virtual Reality Environment.

FIG. 13 is an exemplary embodiment of a System for Spatial Audio Production and Virtual Reality Environment.

FIG. 14 is an exemplary embodiment of a System for Spatial Audio Production and Virtual Reality Environment.

FIG. 15 is an exemplary embodiment of a System for Spatial Audio Production and Virtual Reality Environment.

FIG. 16 is an exemplary embodiment of a System for Spatial Audio Production and Virtual Reality Environment.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description discussion of several terms used herein follows.

As used herein, the word “exemplary” means “serving as an example, instance or illustration.” The embodiments described herein are not limiting, but rather are exemplary only. It should be understood that the described embodiments are not necessarily to be construed as preferred or advantageous over other embodiments. Moreover, the terms “embodiments of the invention”, “embodiments” or “invention” do not require that all embodiments of the invention include the discussed feature, advantage or mode of operation.

Further, many embodiments are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, these sequences of actions described herein can be considered to be embodied entirely within any form of computer readable storage medium having stored therein a corresponding set of computer instructions that upon execution would cause an associated processor to perform the functionality described herein. Thus, the various aspects of the invention may be embodied in a number of different forms, all of which have been contemplated to be within the scope of the claimed subject matter. In addition, for each of the embodiments described herein, the corresponding form of any such embodiments may be described herein as, for example, “logic configured to” perform the described action.

According to an exemplary embodiment, and referring generally to the Figures, various exemplary implementations of a system, platform, device, and method for spatial audio production, production of mixed reality environments, and distribution of performances may be provided. According to some exemplary embodiments, the implementations may provide a powerful drag-and-drop style creation tool, which may enable artists to produce fully interactive virtual venues which can host virtual performances by artists. Performances may be transmitted to a global audience through a suite of XR applications for virtual reality (VR), desktop, and smartphone platforms via audiovisual streaming technology, which may optionally be supported by a cloud-based streaming stack. By improving the production and performance technology as described, the implementations may democratize the creation of high-quality immersive XR experiences and create new forms of artistic expression, while simplifying the creation process for artists without third-party developers and programmers.

The creation platform may include a desktop application providing a flexible 3D environment editor, allowing drag-and-drop-style configuration of complex virtual worlds. In addition to optional templates, the editor may also include a marketplace of digital assets that can be populated by third party or independent visual artists. The creation platform may directly integrate with existing digital audio workstations to integrate existing performance workflows into mixed reality performances. It may further include capabilities for scheduling and monetizing performances and live streams, as well as for realtime feedback from audience members during performances, including viewership statistics. During a performance, the platform may collate audio, video, and musical metadata from an artists' music performance software, such as notes currently being played on a keyboard or effects currently applying to digital instruments, tag it with proprietary time code information, and transmit it via a server infrastructure to compatible XR applications, where it may be decoded and displayed in the artists' virtual world. The virtual worlds may be fully interactive for audience members, allowing physical gestures to be converted into reactive visuals alongside the audiovisual data from the artists' performance.

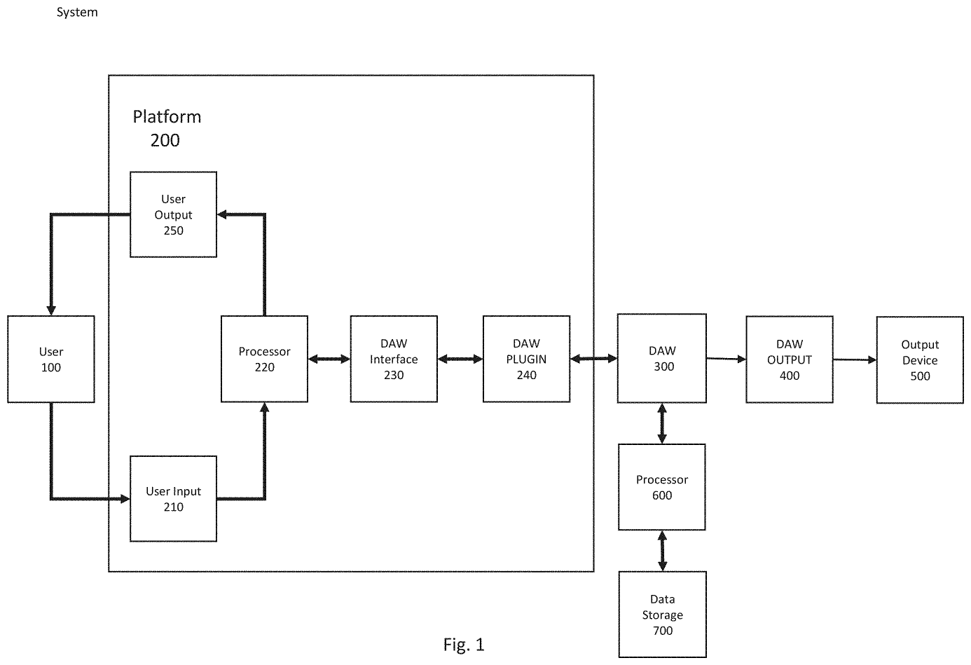

Referring to exemplary FIG. 1, FIG. 1 may show an exemplary embodiment of a system for spatial audio production. A system for spatial audio production may be engaged by a user 100 and may include, a Platform 200, a DAW 300, a DAW Output 400, an Output Device 500, a Processor 600, and Data Storage 700. A User 100 may be a composer, a producer, a musician, or an amateur enthusiast. The DAW 300 may be any digital audio workstation capable of editing spatial audio and creating one or more audio objects 400. The platform 200 may include user input 210, a processor 220, DAW interface 230, data storage 240, and user output 250. The DAW 300 may contain one or more audio objects. The DAW 300 may include Track Automation Envelopes with data about audio objects. The DAW 300 may exchange information regarding the audio object(s) with a DAW Plugin 240. For example, in one embodiment the DAW Plugin 240 may be configured such that an artist can create an object in a DAW, which the plugin then converts into a virtual experience that an audience can experience in VR, AR or mixed reality. In another embodiment, an artist may specify objects to appear and may correlate objects to certain audio objects, sounds, or options. Information exchanged may include waveform data. The DAW Plugin 240 may then translate data for a DAW Interface 230 for the platform 200. The processor 220 may produce an output representation of the associated data and DAW 300. The user output 250 may be achieved through virtual reality, augmented reality, or any other form of mixed reality. The user output 250 my include headsets, phones, personal devices, consoles, or any other device capable of virtual, augmented, or mixed reality. The user output 250 may include visual and other sensory components and representations. The system may provide for editing of associated data by monitoring actions of a user 100. The actions may be performed with physical movement. The actions may be captured by the user input 210. The user input 210 may be obtained from photosensors or any other detector. User input 210 may be recorded using hand gesture recognition or motion detectors capable of identifying specific movements. The processor 220 may combine the captured user input 210 with the data on the audio object(s). The platform 200 may send information back to the DAW 300 through the DAW Plugin 240. The DAW 300 may produce DAW Output(s) 400. The DAW Output may include one or more audio objects. Audio object(s) may include specific parameters correlating to the intended output. Parameters of audio objects may include the X, Y, Z of each of Position, Scale and Rotation. The X, Y, Z of position may map to a spatializing plugin in the DAW. This may be used to correlate the visual 3D appearance of the objects in the system with their linked stem/track/midi instrument audible spatial output. The DAW may operate on a processor 600. The processor 600 may save data to data storage 700. The DAW Output 400 may go to an Output Device 500. The Output Device 500 may then produce audio based on the DAW Output 400. The DAW Output 500 may also include visual components.

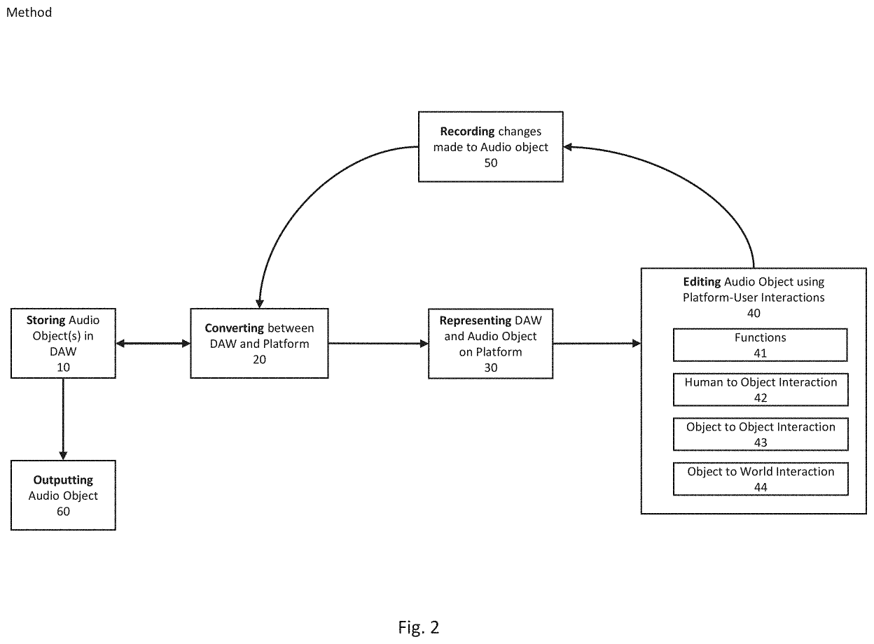

Turning now to exemplary FIG. 2, FIG. 2 may show an exemplary embodiment of a Method For Spatial Audio Production. A Method for Spatial Audio Production may include Storing Audio Object(s) in DAW 10, Converting between DAW and Platform 20, Representing DAW and Audio Object on Platform 30, Editing Audio Object on Platform 40, Recording Changes Made to Audio Object 50, and Outputting Audio Object 60. Storing audio objects in DAW may be done in any digital audio workstation capable of storing spatial audio. Converting between the DAW and the platform 20 may allow for the platform to obtain information about the audio object and DAW controls. Converting between DAW and platform 20 may be achieved using a DAW Plugin 240. Representing DAW and Audio Object on Platform 30 may provide a virtual reality, augmented reality, or any other kind of mixed reality representation of the audio object and DAW for a user. Representing on Platform 30 may be done using augmented reality goggles, Virtual Reality technology, on a desktop, and/or on a mobile device, Based on the presentation, the user may then conduct the Editing Audio Object On Platform 40 step. Editing Audio Object on Platform 40 may include functions 41 to adjust aspects of the spatial audio. Editing Audio Object on Platform 40 may also include Human to Object Interaction 42, Object to Object Interaction 43, and Object to World Interaction 44. Recording changes made to Audio Object 50 may save any changes made to the audio object. The changes may be saved on the platform itself or converted to the DAW and saved there. Finally, Outputting Audio Object 60 may be done with headphones, speaker systems, in a different virtual reality setting, or through any other means of playing audio. Outputting Audio Object may also include visual components like LED lighting, virtual reality displays, or any other representation correlating to the spatial audio produced. The playback may be immediate and/or in the future from a recorded or saved file.

Functions 41 may include selection, zooming to specifics of object, scrolling through a timeline, deleting, twirling relative to the user within the soundscape, zooming in the soundscape relative to the user, panning relative to the user around the soundscape, copying, pasting, writing midis, increasing, decreasing, drawing, drawing motion paths, drawing object shapes, cutting, highlighting, saving, recording, mapping common gestures, adjusting volume, moving through space, moving forward, moving backward, adjusting scale of movement, rotating object in XY, YZ, and XZ planes, jumping locations, quantum effects, changing objects as user parameters change, and any other function that may help in the editing, creation, revision, or representation or spatial audio.

Human to object interactions 42 may include individual gestures, one handed gestures, two handed gestures, movement changes, static hand uses, and any other physical form of communication. One handed gestures may include tapping, double tapping, triple-tapping, clicking and holding, drawing triangles, circles, squares, or any other shapes, drawing slashes up and down, left and right, forward and backward, twisting hands clockwise and counterclockwise. Two handed gestures may include moving hands forward, backward, left, right, up, down or in any other combined direction, moving hands closer together or farther apart, twisting hands in or out together, tapping with both hands, holding an object in one hand while making a gesture with another, or any other recognizable gesture. Movement changes may include acceleration and deceleration of body parts, throwing motions, whipping back, proximity to other objects, and any other identifiable movement, as would be understood by a person having ordinary skill in the art.

Object to object interactions 43 may replicate real world interactions in a virtual world. This may include gravitational forces between audio objects, collisions, or any other such interaction. This may allow for generative randomness within the audio object to adjust the output. Real world interactions may be achieved using physics engines to generate interactions and any randomness therein. Object to object interactions 43 may include gravitational forces between objects or the user, repulsion, collision, valance objects, links between objects, explosions, orbits, springs, recoils, halos of effects, occlusions, null objects, features of hardness and absorption, or any other potential interaction between objects 400.

Object to world interactions 44 may allow for virtual objects to interact with the world to affect and be affected by the world. This may involve changing the shape and size of the virtual environment to correspond to parameters in a convolution reverb effect on a master channel. Object to World interactions 44 may include automated motion, automated path generation of imported 3D models, gravity, repulsion, bouncing, viscosity, soundscape size and dimensions, boundary bouncing, and teleportation movement of objects around the soundscape.

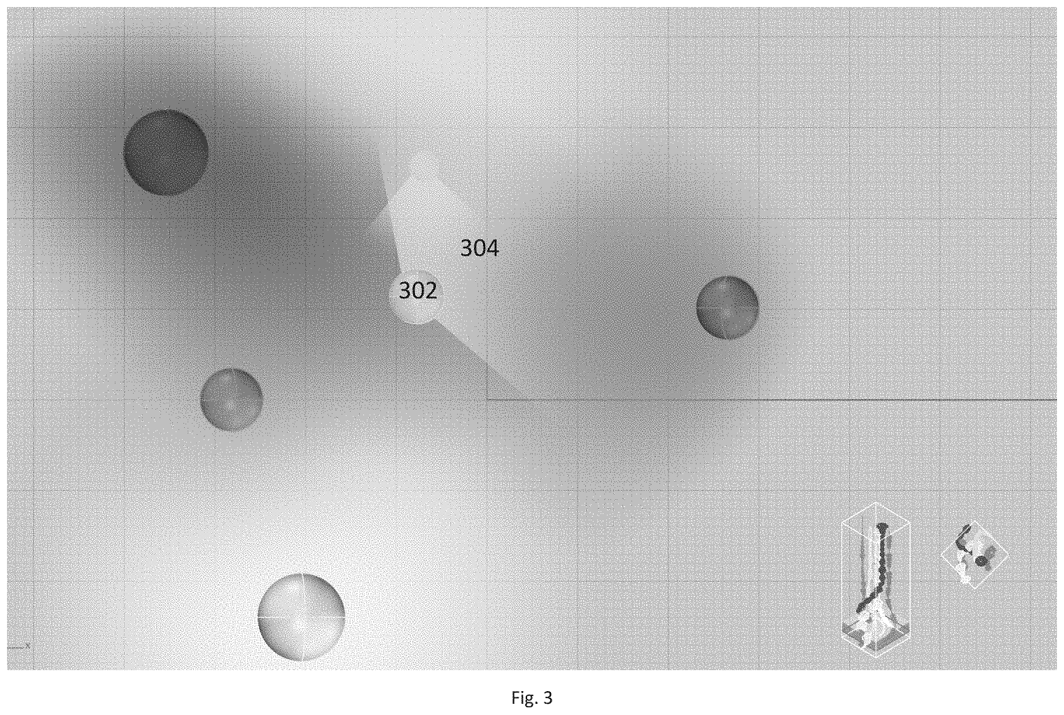

Referring now to FIG. 3, FIG. 3 may illustrate an exemplary representation of spatialized audio in a virtual environment. In this exemplary embodiment, multiple virtual audio objects 302 may be within a 2D or 3D virtual space. An object 302 may have a cone 304 which indicates which direction the audio object faces. For example, a user might only hear audio from an audio object 302 when the user is standing within the cone 304.

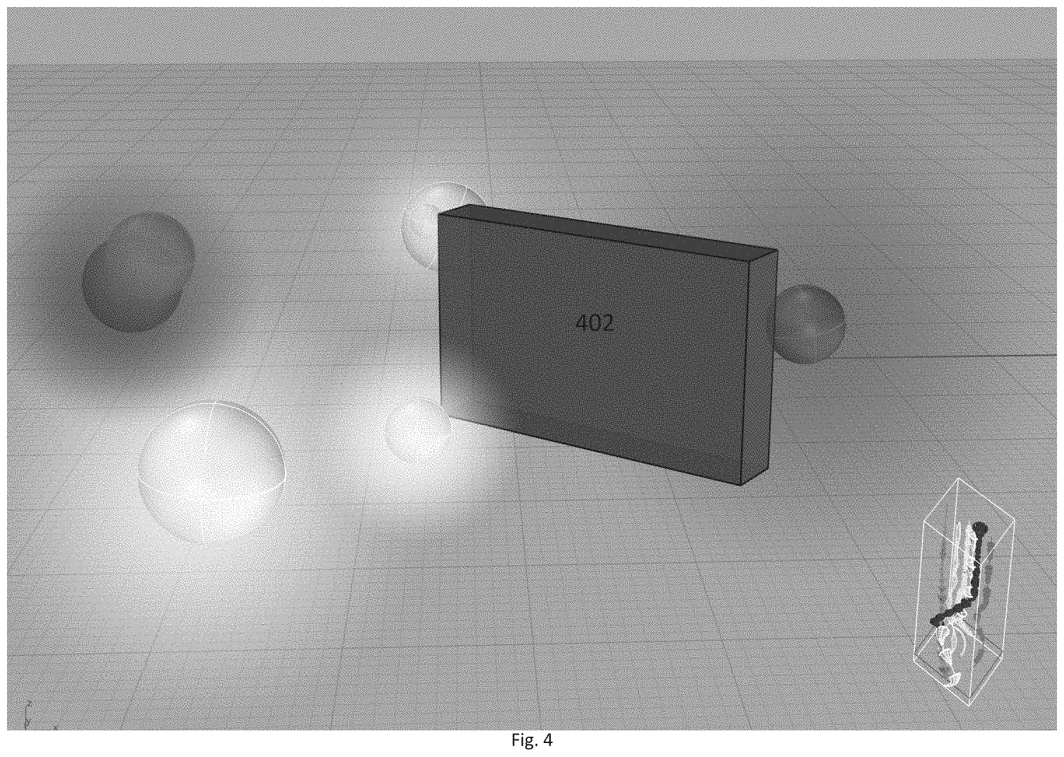

Referring now to FIG. 4, FIG. 4 may illustrate another exemplary representation of spatialized audio in a virtual environment. In this exemplary embodiment, a non-audio virtual object 402 may be illustrated. When placed between a user and an audio object, the non-audio object 402 may block or muffle audio from the corresponding blocked audio object.

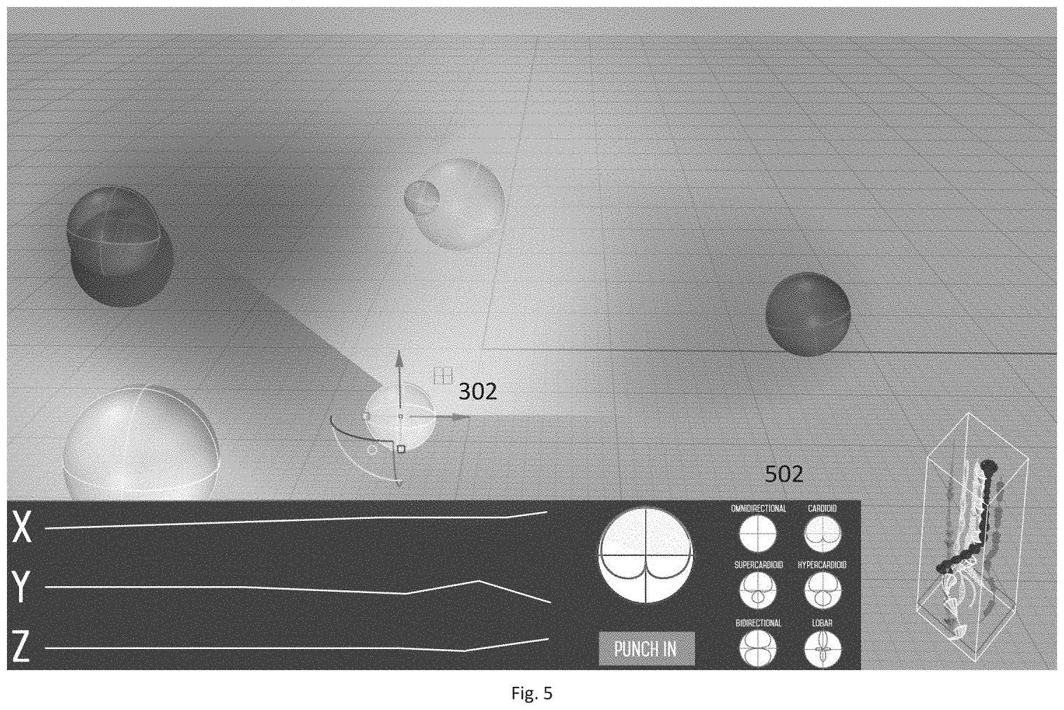

Referring now to FIG. 5, FIG. 5 may illustrate another exemplary representation of spatialized audio in a virtual environment. In this embodiment, various attributes 502 corresponding to the virtual audio object 302 may be illustrated. For example, a user may change the X, Y, and Z coordinates and/or dimensions of each object. Other options may be selected, including but not limited to omnidirectional, cardioid, supercardioid, hypercardioid, bidirectional, and lobar options.

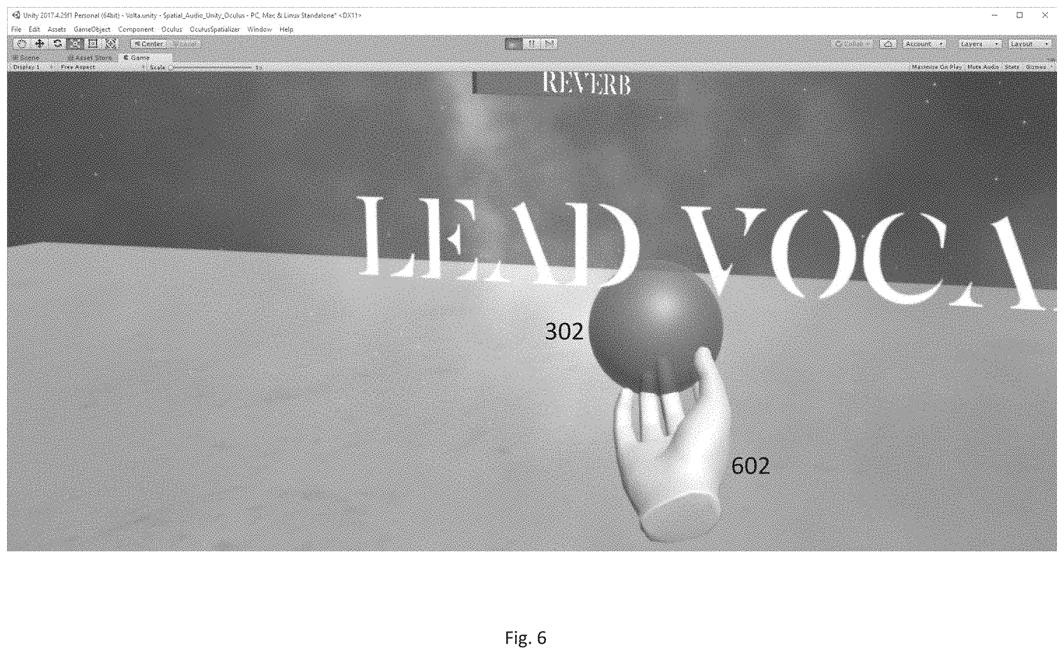

Referring now to FIG. 6, FIG. 6 may illustrate an exemplary representation of spatialized audio in a virtual reality environment. In this exemplary embodiment, a user may interact with the audio objects 302 using hand motions, which may be represented in the environment by a virtual hand 602. Further, it may be contemplated that the audio objects 302 may include textual labels to indicate what audio is being represented by each object 302.

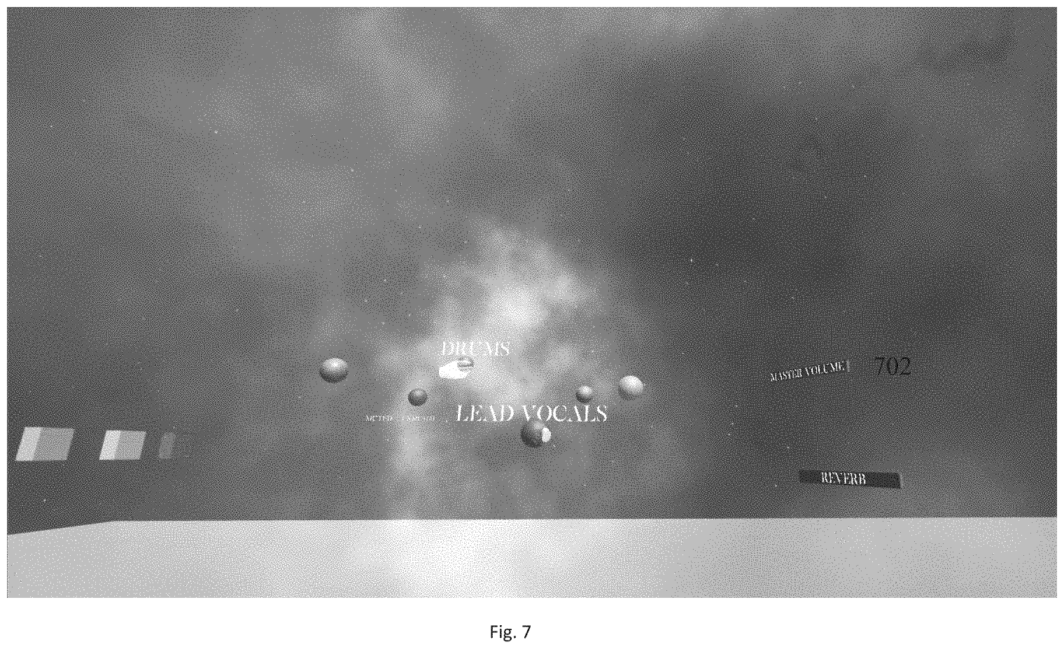

Referring now to FIG. 7, FIG. 7 may illustrate another exemplary representation of spatialized audio in a virtual reality environment. In this exemplary embodiment, illustrated objects may represent additional options in other formats. For example, the master volume 702 may be illustrated as a rectangular slider. Other objects may be represented as cubes, spheres, or any other contemplated shape.

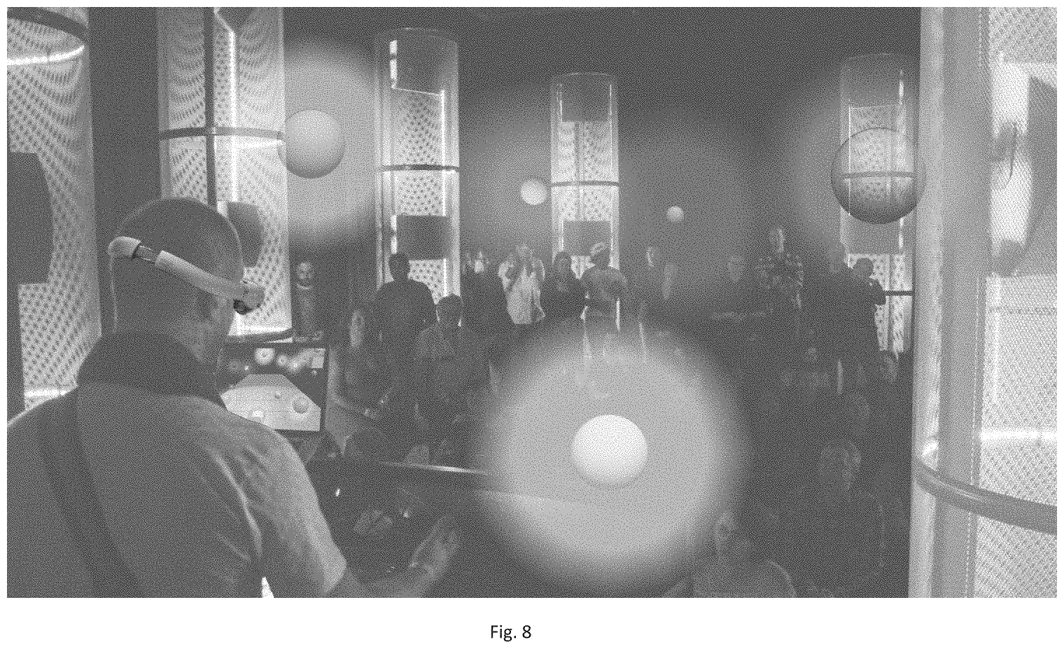

Referring now to FIG. 8, FIG. 8 may illustrate an exemplary representation of spatialized audio in an augmented reality environment. In this exemplary embodiment, audio objects 302 may be overlayed on the user's surrounding environment. Multiple users may be located near one another in the real-world, and may see the same audio objects in the same places. In an exemplary embodiment, an artist or content creator may place the objects throughout the environment. Augmented reality devices may be used to view the virtual objects. Alternatively, it may be contemplated that the virtual objects are projected onto the real-world environment using a projector or via other means, such that audience members may view and/or interact with the objects without augmented reality devices, headsets, or goggles.

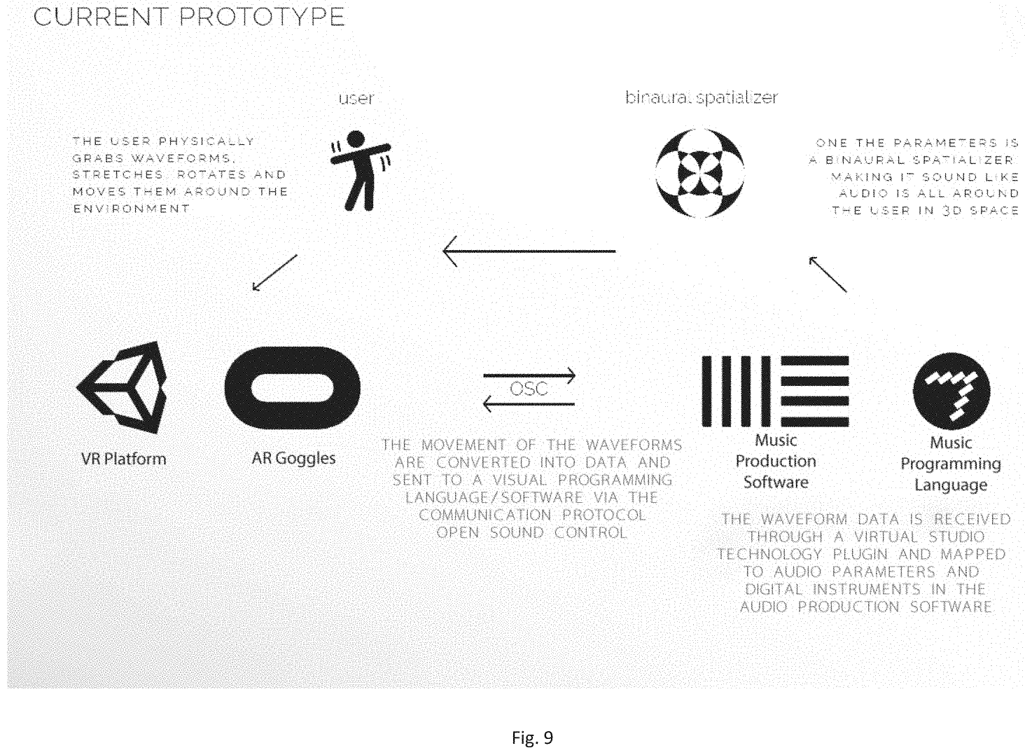

FIG. 9 may show an exemplary embodiment of a system for spatialized audio production. The system may include a binaural spatializer, a DAW, movement of waveforms, a Virtual Studio Technology (VST) Plugin, and may allow for engagement by a user. The user may physically grab waveforms and stretch, rotate, or move them in a virtual environment through capturing of user input, which may include capturing user movements, biometrics, or indicators, as would be understood by a person having ordinary skill in the art. The user movement may correlate to changes in data in a DAW. The changes in data may be translated by a VST Plugin. A Binaural spatializer may then take the data and produce spatialized audio which sounds like it is all around the user in a 3D space.

In one exemplary embodiment, a user may be in a virtual reality environment and see the spatialized audio surround them. The user could then move to individual aspects of the audio and physically stretch or contract the audio to adjust the way it sounds when produced as spatialized audio.

In another exemplary embodiment, the user could use augmented reality goggles to view the spatialized audio overlain with the real world. The user may then be able to see the objects simultaneously as they hear them and visualize the elements of the audio as it is produced. The user may also be able to interact with the audio and affect it with their own movements or the movements of real world and virtual objects around them.

In another exemplary embodiment, the spatialized audio may be depicted on a desktop tethered to a mobile device with an augmented reality core. The user may be able to place audio objects around their room which are visualized on the screen. The user may then additionally be able to manipulate the objects with additional physical interactions with their surroundings.

In an exemplary embodiment an audience may view and interact with the spatialized audio in a virtual environment. For example, an audience member may add instruments, control audio settings, raise or lower volume, and perform any other contemplated adjustments. Further, the audience member's location in relation to the audio objects in the virtual environment may determine some parameters regarding how the audience member receives or hears the audio. An audience member may be able to move within the virtual environment to be closer or farther from certain audio objects. Alternatively, the audio objects may be moved around in the virtual environment.

In a further exemplary embodiment, an audience member may control some 3D object within a virtual environment. For example, a virtual 3D instrument may appear in the virtual environment. The virtual instrument may be played by the audience member. In an exemplary embodiment, motion data may be recorded from the audience member. For example, an exemplary embodiment may record motion data while an audience member is playing a virtual instrument in order to simulate the audience member's performance. Other data other than motion data may be used as input for simulating the performance, such as sound data or any other contemplated data. It may be contemplated that the audience member performs on an actual instrument which is then converted into a virtual instrument and/or a virtual performance.

It may be contemplated that audience members may be able to interact with one another. Multiple audience members may participate in or view a performance simultaneously. The audience members may view the performance in virtual reality. In an embodiment, the audience members may view the performance in first-person. It may be contemplated that each audience member has a unique first-person view of the performance. Each audience member may be at a unique location in the virtual environment where the virtual performance takes place, and therefore may have a unique experience or view of the performance. It may be contemplated that the performance is performed live, and the audience members participate in and view the performance in real-time. The live performance may then be stored for later viewing.

In another exemplary embodiment, the virtual environment may be a location in a video game. A performance may occur at a certain location within the virtual map of a video game. Players may navigate to the location in order to participate in or view the performance.

According to an exemplary embodiment, objects, including audio and non-audio objects, may optionally be manipulated, moved, or rearranged by one or more of artists or audience members and the manipulation, movement, or rearrangement may also be restricted based on permissions set by an artist, creator, host, or subscription/access permission level. Furthermore, some or all of the manipulations by an audience member may optionally be experienced by other audience members.

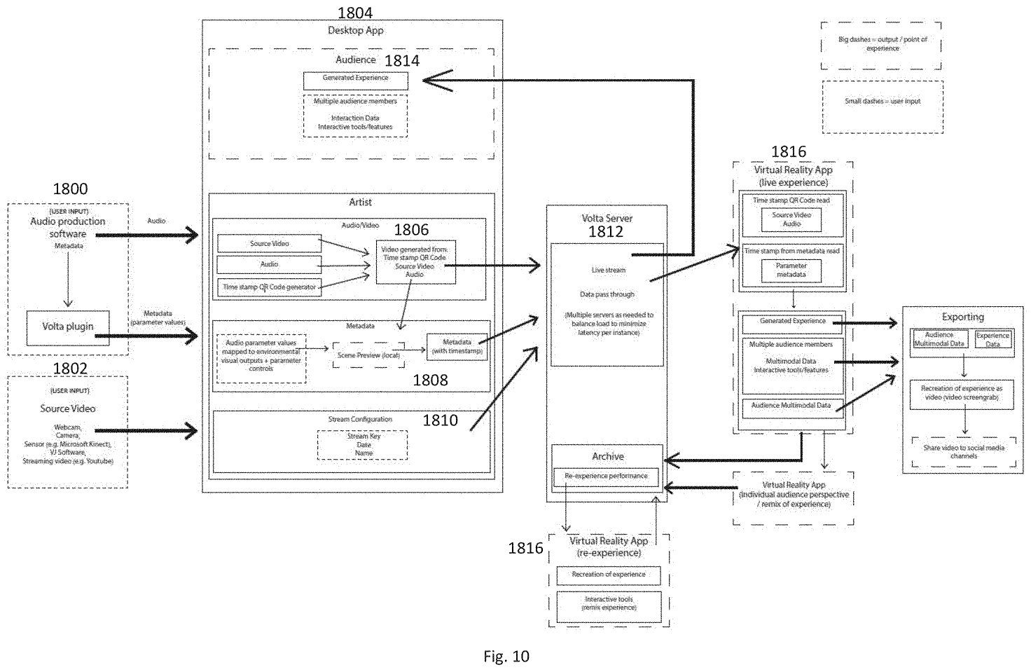

Referring now to FIG. 10, FIG. 10 illustrates an exemplary system configuration. Audio production software 1800 and/or a source video 1802 may be used as input to an exemplary system. The audio production software 1800 may be a digital audio workstation. Audio may be output from the audio production software 1800 into the system. In an exemplary embodiment, metadata may also be extracted from the software 1800. A source video 1802 may be obtained from, for example, a webcam, 3D sensor, VJ software, a streaming video, a camera, or any other contemplated video device or software.

The audio and metadata from the audio production software 1800, and the video 1802 may be loaded into an app 1804 in an exemplary embodiment. The app may be a mobile or desktop app. The app 1804 may combine the audio and source video with a time stamp QR code 1806. The metadata 1808, which may include parameter values relating to the audio, may be mapped to environmental visual outputs and parameter controls. For example, the level of bass may be included in the metadata as an audio parameter value. The level of bass may then be mapped to an environmental visual output, such as a sphere that appears in the virtual environment. Further, parameter controls may be mapped to the sphere. For example, one configuration may raise the level of the bass when the sphere is made larger by the user or artist and vice versa. A variety of other manipulations and effects may be performed, as would be understood by a person having ordinary skill in the art. Additionally, a parameter may be manipulated and the change in that parameter may be reflected in the virtual environment. Referring to the previous example for illustrative purposes, if the user increases the level of the bass or treble using a digital audio workstation or some other means, the sphere representing the bass may increase in size accordingly. Conversely, the interactive visual may affect the bass in the audio source or the bass in a native environment, not needing to communicate with the audio source.

In an exemplary embodiment, a user or artist may preview the scene before live streaming while adjusting the metadata. A stream configuration 1810 may be initialized, and may include a stream key, date, and name. A video may then be generated from the source video, audio, timestamp QR code, metadata, and stream configuration. The video may be passed to an exemplary server 1812. The server 1812 may be configured to live stream a performance by passing the data to an audience. Additionally, the server may be configured to store an archive of previous performances which may be re-experienced by artists, audiences, or users. An audience 1814 may access the server 1812 via the desktop app 1804 in order to participate or interact with a performance.

In an exemplary embodiment, a virtual reality app 1816 may access the server 1812 in order to experience or re-experience a performance. The VR app 1816 may obtain the timestamp QR code. Source video, audio, and parameter metadata in order to provide a user or audience member a unique experience. Multiple audience members may experience a performance simultaneously. Further, audience members may interact with the performance, so the virtual reality app 1816 may also export data. For example, interaction data, audience multimodal data and experience data may be exported in order to recreate the experience for future use or as a video. In an exemplary embodiment, interaction data may include any input made by audience members. For example, interaction data may be cheering, dancing, singing, or any other contemplated action carried out by an audience member. In some embodiments, audience members may play virtual (or real) instruments, which may be reflected in the interaction data.

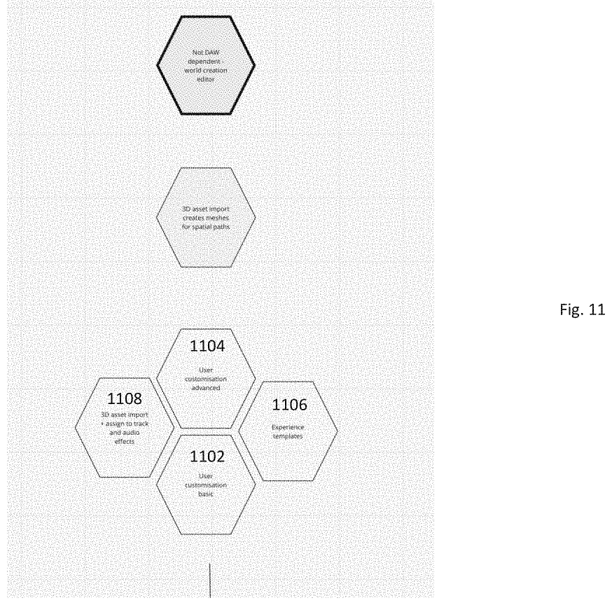

Referring now to FIG. 11, FIG. 11 may illustrate an exemplary schematic flowchart of a user customization module. In this example, the user may choose from basic customization options 1102, advanced customization options 1104, templates 1106, or the user may import 3D assets 1108. It may be contemplated that importing 3D assets 1108 may create meshes for spatial paths. The customization options may be independent of the digital audio workstation. In an exemplary embodiment, the options may be selected in a world creation editor.

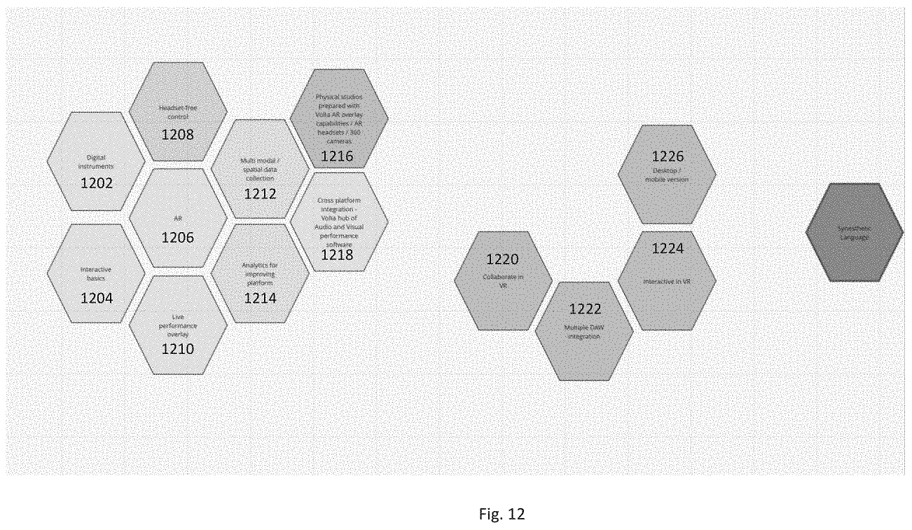

FIG. 12 may illustrate an exemplary schematic of a virtual reality module. This exemplary embodiment may include digital instruments 1202, interactive controls 1204, an augmented reality (AR) component 1206, headset-free controls 1208, a live performance overlay 1210, multi-modal/spatial data collection 1212, and analytics for improving the platform 1214. Physical studios may be prepared with an AR overlay which may be viewed with or without AR headsets and may implement 360-degree cameras 1216. Cross platform integration may be contemplated which integrates audio and visual performance software 1218.

Still referring to FIG. 12, an embodiment may allow multiple users to collaborate in VR 1220. Further, multiple DAWs may be integrated and combined 1222 in an exemplary collaboration space. The collaboration space may be interactive in virtual reality 1224. An exemplary embodiment may provide a desktop and/or a mobile implementation 1226.

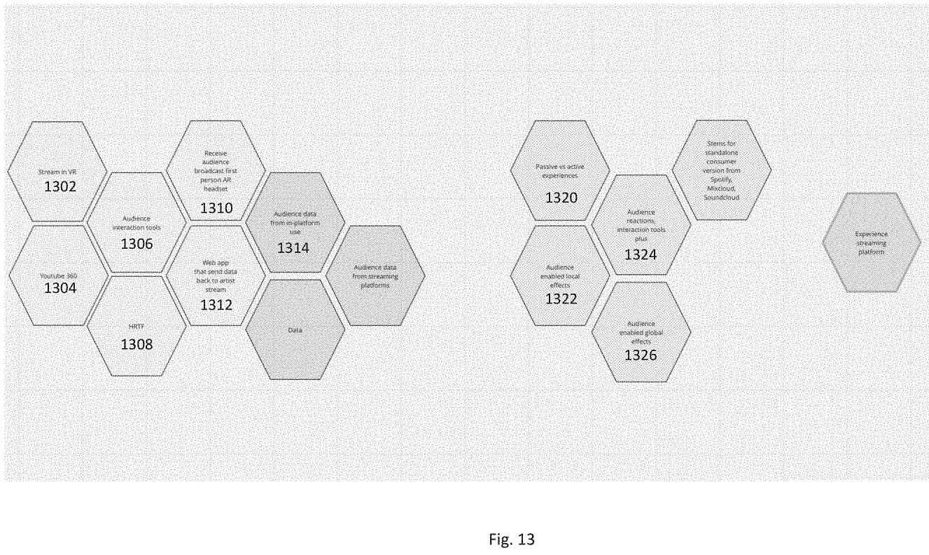

FIG. 13 may illustrate a schematic of an exemplary streaming module. An embodiment may provide for streaming in VR 1302. In another exemplary embodiment, the audience may have interactive controls 1306. A head related transfer function (HRTF) 1308 may be implemented in the stream to determine the direction of arrival of a sound source as well as be used to control the desktop window from a user's head movement. An audience broadcast may be shown in the first-person view in an AR headset 1310. The audience interaction may be recorded, and corresponding data may be sent back to the artist stream 1312. Audience data may be recorded in the use of the platform 1314.

An exemplary embodiment may differentiate between passive and active experiences 1320, where active experiences provide for audience-enabled local effects 1322, audience reactions 1324, audience enabled global effects 1326, and the like. Passive experiences may restrict audience-enabled local effects, reactions, audience enabled global effects and other aspects as would be understood by a person having ordinary skill in the art.

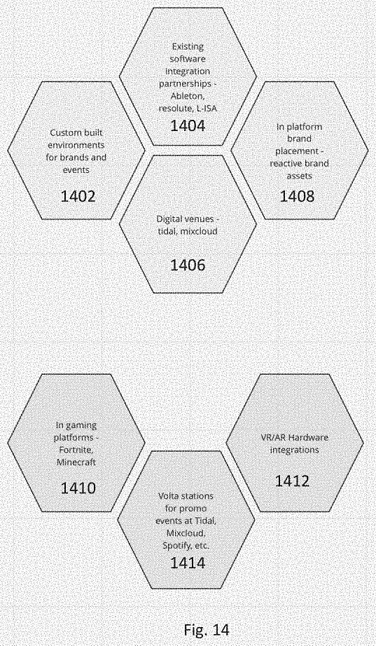

FIG. 14 may provide an exemplary schematic of an integration platform. In an exemplary embodiment, environments may be custom built for certain brands and events 1402. Existing software may also be integrated 1404 as well as digital venues 1406. In-platform brand placement and reactive brand assets may be integrated 1408. Another exemplary embodiment may provide in-game platforms 1410. For example, it may be contemplated that a virtual environment is implemented within an existing videogame. In another embodiment, VR/AR hardware integrations may be provided 1412, and may be displayed in stations or kiosks at events 1414.

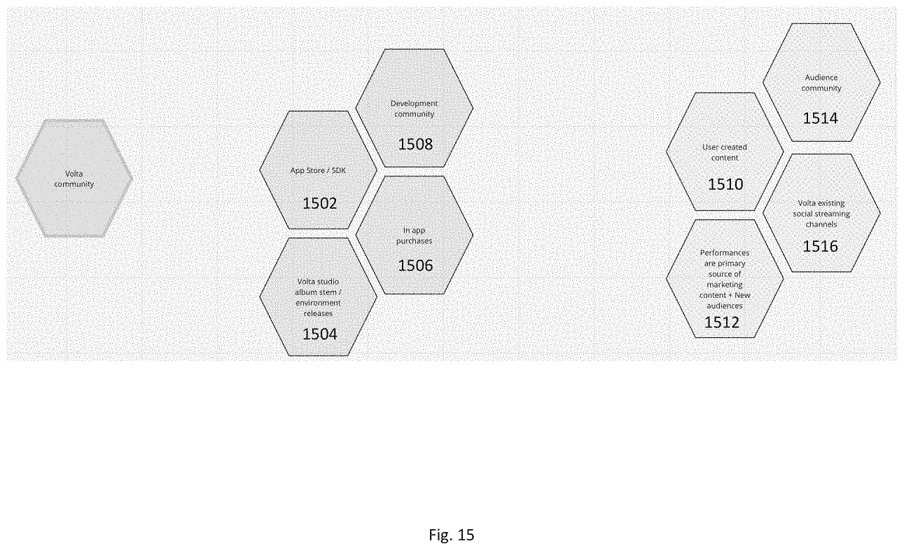

FIG. 15 may provide an exemplary schematic of a community platform. The community platform may include an app store or software development kit (SDK) 1502. The community 1502 may provide a studio album stem or environment releases 1504. The releases 1504 and other content may be available via in-app purchases 1506, as would be understood by a person having ordinary skill in the art. A development community 1508 may be provided that may allow for collaboration in the development of implementations. User created content 1510 may be hosted in the community module. For example, performances may provide additional marketing content 1512. Further, an audience community 1514 may be provided where audience members can discuss or collaborate. Existing social streaming channels may also be integrated to the community module 1516.

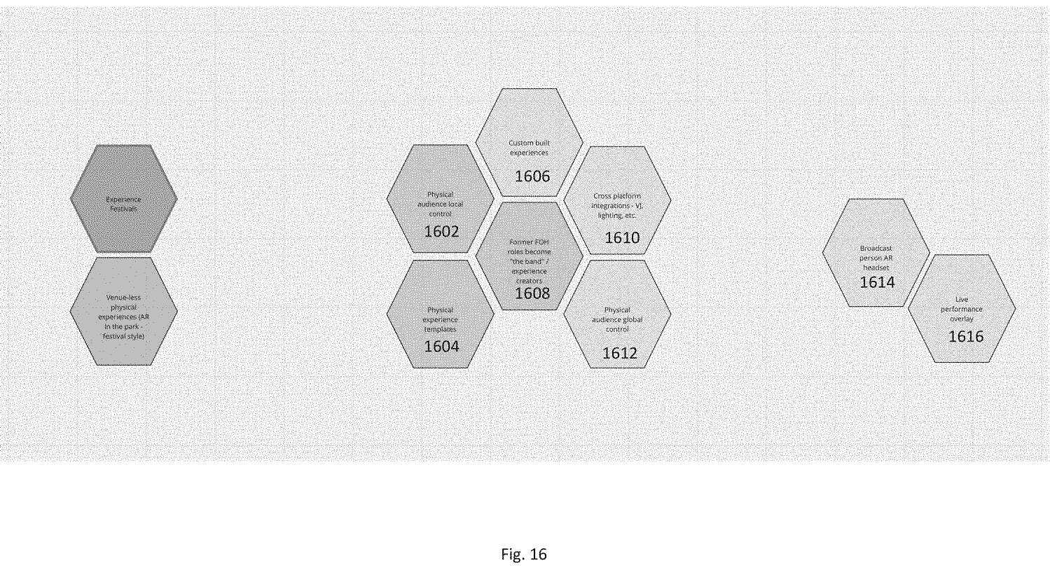

FIG. 16 may illustrate an exemplary schematic of a virtual experience module. The virtual experience module may provide a venue-less physical experience. For example, augmented reality may be implemented in an open field or park. The audience may have local control over the environment 1602. The virtual environment may be loaded from physical experience templates 1604. Alternatively, custom-built experiences may be created 1606. Experience creators may be a band or other content creator 1608. An exemplary embodiment may also have cross platform integrations 1610, such as for lighting. The physical audience may control various aspects of the environment 1612. A broadcaster 1614 may use an AR headset to view a live performance overlay 1616.

An exemplary embodiment may provide an SKI and API for developers. For example, developers may choose assets, physics, instruments, outfits, and the like from a marketplace or database. The chosen items may be used by audience members, artists, developers, and content creators.

Another exemplary embodiment may be incorporated into an existing virtual environment, such as a video game, where the artist or content creator may control some elements of the game. For example, the artist may control some visual and audio elements. It may be contemplated that users of the game navigate to a specific area or module in order to participate in the artist's production.

In yet another exemplary embodiment, a system for converting music into a fully interactive virtual reality experience may be provided. Certain aspects of the music may be broken down into virtual objects. For example, the drums may be one virtual object while vocals are represented by another virtual object.

An exemplary embodiment may implement artificial intelligence (AI) and/or machine learning algorithms. For example, AI may be used to generate 3D assets in the environment, as original 3D assets, and may output assets as the differential between types of 3D assets. An embodiment may implement AI, machine learning, or neural networks to detect objects in a video, such as a live feed, and may use 3D sensors, LIDAR sensors, and other sensors as would be understood by a person having ordinary skill in the art. Another exemplary embodiment may correlate biometric data of a user to produce a desired output in the environment.

In an exemplary embodiment, computer vision techniques may be implemented to detect the orientation of a user's head (based on a feed from, for example, the user's webcam), in order to control the perspective and orientation of the entertainment environment when viewed in the desktop application.

Another exemplary embodiment may implement haptics and haptic feedback. For example, sound, interactions, and visuals may create haptic feedback through the use of, for example, VR hand controllers and other similar devices. An embodiment may be used in augmented reality, such as for mobile AR applications, as well as AR googles.

The integration of frameworks for social interaction may allow people to interact with each other remotely in VR, using desktop and mobile apps and any combination thereof. People may interact by talking, manipulating the world around them, or by manipulating the audio/visual environment. People may remotely share digital tools, instruments, and/or assets in an exemplary embodiment, which may affect or manipulate the environment, sound, visuals, and other aspects of the immersive virtual world. An exemplary embodiment may allow multiple users to contribute to and collaborate on experiences, thus facilitating the creation or editing of narratives or longer experiences, allowing layers of sub-experiences, or branching experiences within a single experience. It may be contemplated that an exemplary embodiment provides for the creation of webs of experiences.

Thus, an exemplary embodiment may automatically configure an immersive broadcastable world with little to no intervention by the artist/broadcaster. An exemplary embodiment may allow artists/broadcasters to easily drag and drop 3D assets that are mappable to any audio parameters and any video.

An embodiment may provide for a limitation or restriction of an event to certain users. For example, an embodiment may allow an artist to only admit audience members after they have paid for a ticket, akin to a concert or other live performance. The artist may collect a ticketing fee for live or pre-recorded multimodal experiences. An exemplary embodiment may allow artists to sell the ownership of experiences to another, giving the other person full control over how to use or disseminate the experience, akin to a painter selling their painting. Ownership and control may be transferred to some or all aspects of an experience. It may be contemplated that an exemplary embodiment allows for the issuance of credit to artists and audience members/attendees on the platform to pay for items on the platform, such as, for example, tickets, archived experiences, in-app purchases, exclusive experiences, or donations.

Another exemplary embodiment may be implemented to control, broadcast to, and integrate into certain elements of other existing external games and applications. For example, musicians may use an exemplary embodiment to broadcast music and to control non-essential aesthetic elements (such as colors of the sky, or movement of other auxiliary game elements) of a game. The game may be an online game, such as an online multiplayer game.

The foregoing description and accompanying figures illustrate the principles, preferred embodiments and modes of operation of the invention. However, the invention should not be construed as being limited to the particular embodiments discussed above. Additional variations of the embodiments discussed above will be appreciated by those skilled in the art (for example, features associated with certain configurations of the invention may instead be associated with any other configurations of the invention, as desired).

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A system for providing an audio-visual event, comprising:
audio production software, the audio production software configured to provide audio and audio metadata to a server, wherein the audio metadata comprises one or more adjustable parameters related to the audio;
a source video;
a desktop application configured to combine the audio, audio metadata, and source video;
a server configured to store and stream the combined audio, audio metadata, and source video;
a virtual reality application configured to access the server to display the combined audio, audio metadata, and source video;
wherein the source video, audio, and audio metadata are provided by an artist;
wherein the virtual reality app also receives a set of audience data relating to one or more audience members, and wherein the audience members simultaneously access the virtual reality app to simultaneously view the audio-visual event.

2. The system of claim 1, wherein each adjustable parameter of the audio metadata is mapped to a plurality of environmental visual outputs, wherein the environmental visual outputs are adjustable, and wherein adjustments made to the environmental visual outputs are then made to the audio metadata adjustable parameters.

3. The system of claim 1, wherein the server stores the audio-visual performance and the virtual reality application can access the stored audio-visual performance.

4. The system of claim 2, further comprising a plurality of motion sensors, wherein the motion sensors are configured to capture motion data, and wherein the adjustments made to the environmental visual outputs are based on the captured motion data.

5. The system of claim 2, wherein the source video is from a three-dimensional camera or sensor.

6. The system of claim 1, wherein the source video is a live-stream of the audio-visual event.

7. A method for producing an audio-visual event, comprising:
capturing a source video from a performer;
capturing an audio from the performer or an audio production software;
mapping the audio to a virtual environment, wherein a plurality of audio parameter values are mapped to a plurality of environmental visual outputs;
adjusting the audio parameter values by interacting with the environmental visual outputs, and updating the audio based on the adjusted audio parameter values;
combining the audio and source video in a virtual environment hosted on a server.

8. The method of claim 7, wherein the source video and audio are obtained live from the performer.

9. The method of claim 7, wherein the virtual environment on the server is accessed by a plurality of audience members.

10. The method of claim 9, further comprising receiving interaction data from the plurality of audience members, and updating the virtual environment on the server based on the interaction data.

11. The method of claim 10, wherein each audience member experiences the virtual environment in a first-person view that is unique to each audience member.

12. A non-transitory computer-readable medium containing program code for producing an audio-visual event that, when executed, causes a processor to perform steps of:
capturing a source video from a performer;
capturing an audio from a user or an audio production software;
mapping the audio to a virtual environment, wherein a plurality of audio parameter values are mapped to a plurality of environmental visual outputs;
adjusting the audio parameter values based on interactions with the environmental visual outputs, and updating the audio based on the adjusted audio parameter values;
combining the audio and source video in a virtual environment hosted on a server.

13. The computer program product of claim 12, wherein the source video and audio are captured from a live stream of the performer.

14. The computer program product of claim 12, further comprising the step of storing the combined audio and video on the server.

15. The computer program product of claim 12, further comprising streaming the virtual environment to a plurality of audience members.

16. The computer program product of claim 15, further comprising receiving a set of interaction data from the audience members and updating the virtual environment on the server, in real time, to reflect the interaction data.
